(19) United States
(12) Patent Application Publication
(10) Pub. No.: US 2026/0369913 A1
(43) Pub. Date: Nov. 19, 2026

(54) Data Storage Device with a Biasing Member in a Bottom Enclosure

(71) Applicant: Sandisk Technologies, Inc., Milpitas, CA (US)

(72) Inventors: Ken Sun, Shenzhen (CN); Daniel Wang, Shenzhen (CN)

(73) Assignee: Sandisk Technologies, Inc., Milpitas, CA (US)

(21) Appl. No.: 19/206,664

(22) Filed: May 13, 2025

(51) Int. Cl. H01R 13/44

(52) U.S. Cl. CPC H01R 13/44

(57) ABSTRACT

Some retractable Universal Serial Bus (USB) data storage devices use plastic biasing members (e.g., spring feet) formed on the top or bottom of a plastic movable part to secure/lock the plastic movable part in place in retracted and extended positions. It may be preferred to use a metal movable part instead of a plastic movable part for better heat dissipation, but there can be challenges in placing plastic biasing members on a metal movable part. The embodiments presented herein address this issue by mounting the biasing members in the bottom enclosure of the data storage device instead of on the movable part.

### BACKGROUND

Some Universal Serial Bus (USB) data storage devices (e.g., “thumb drives”) have a connector that is fixed in a position exposed outside of the enclosure of the data storage device. Such devices can include a removable cap that fits over the exposed connector when not in use. Other USB data storage devices have a retractable connector that is movable by a user between a retracted position (where the connector is inside the data storage device's enclosure) and an extended position (where the connector is outside of the data storage device's enclosure). In such devices, a user would slide a button back and forth to move a plastic movable part carrying the connector to expose and retract the connector. A plastic biasing member (e.g., spring feet) can be formed on the plastic movable part for securing/locking the plastic movable part in place in the retracted and extended positions.

FIGS. 14A-B and 15A-C are illustrations of prior art retractable USB data storage devices. In the device shown in FIGS. 14A-B, plastic spring feet 1 are formed on the bottom of a plastic movable part 2, such that the plastic spring feet 1 slide on a bottom enclosure 3 of the device. In the device shown in FIGS. 15A-C, plastic spring feet 4 are formed on the top of a plastic movable part 5, such that the plastic spring feet 4 slide on a top enclosure 6. In operation, the user would push a button 7 (see FIG. 15C) to deform the plastic spring feet 4, which unlocks the plastic movable part 5 and allows the user to slide the plastic movable part 5 between the retracted and extended positions. In this deformed state, the plastic spring feet 4 can provide a smooth and pleasant feeling for the user while sliding the plastic movable part 5.

### BRIEF DESCRIPTION OF THE DRAWINGS

FIG. 1 is an expanded, unassembled view of a data storage device of an embodiment.

FIG. 2 is a semi-transparent view of an assembled data storage device of an embodiment.

FIGS. 3 and 4 are cut-away views of portions of an assembled data storage device of an embodiment.

FIGS. 5 and 6 are side sectional views of an assembled data storage device of an embodiment.

FIG. 7 is a front sectional view of an assembled data storage device of an embodiment.

FIGS. 8-9 are different perspective views of a bottom enclosure of a data storage device of an embodiment.

FIGS. 10-12 are different sectional views of a bottom enclosure of a data storage device of an embodiment.

FIG. 13 is an illustration of a process of assembling a data storage device of an embodiment.

FIGS. 14A-14B are illustrations of a prior art data storage device.

FIGS. 15A-15C are illustrations of a prior art data storage device.

### DETAILED DESCRIPTION

The following embodiments generally relate to a data storage device with a biasing member in a bottom enclosure. In one embodiment, a data storage device is provided comprising a bottom enclosure comprising first and second sidewalls, wherein a pair of grooves are formed in the first and second sidewalls; a biasing member comprising a resilient portion and a mounting portion, wherein the mounting portion is slidably engaged with the pair of grooves; and a connector assembly comprising a connector, wherein the connector assembly is slidable along the resilient portion of the biasing member between a retracted position in which the connector is positioned inside the bottom enclosure and an extended position in which the connector is positioned outside of bottom enclosure, wherein the resilient portion of the biasing member is configured to releasably retain the connector assembly in place.

In another embodiment, a data storage device is provided comprising: a top enclosure; a bottom enclosure comprising first and second sidewalls, wherein first and second pairs of grooves are formed in the first and second sidewalls; a first biasing member comprising a first resilient portion and a first mounting portion, wherein the first mounting portion is slidably engaged with the first pair of grooves; a second biasing member comprising a second resilient portion and a second mounting portion, wherein the second mounting portion is slidably engaged with the second pair of grooves; and a connector assembly positioned between the top and bottom enclosures, the connector assembly comprising a connector, wherein the connector assembly is slidable along the first and second resilient portions of the first and second biasing member between a retracted position in which the connector is positioned inside the bottom enclosure and an extended position in which the connector is positioned outside of bottom enclosure.

In yet another embodiment, a data storage device is provided that is assembled by a process comprising: providing a bottom enclosure comprising first and second sidewalls, wherein first and second pairs of grooves are formed in the first and second sidewalls and a gap exists between the first and second pairs of grooves; placing a first biasing member through the gap, the first biasing member comprising a first resilient portion and a first mounting portion; sliding the first mounting portion of the first biasing member through the first pair of grooves; placing a second biasing member through the gap, the second biasing member comprising a second resilient portion and a second mounting portion; and sliding the second mounting portion of the second biasing member through the second pair of grooves.

Other embodiments are possible, and each of the embodiments can be used alone or together in combination. Accordingly, various embodiments will now be described with reference to the attached drawings.

### Embodiments

As mentioned above, some retractable USB data storage devices use plastic spring feet formed on the top or bottom of a plastic movable part to secure/lock the plastic movable part in place in retracted and extended positions. The plastic movable part carries a printed circuit board, and with the transmission speed of USB flash drives getting faster and faster, heat dissipation for the printed circuit board is becoming more and more important. To assist with heat dissipation, it may be preferred to use a metal movable part instead of a plastic movable part, as metal can provide a good heat sink, which can provide improved heat dissipation and improved read/write speeds. While forming plastic spring feet on a plastic movable part is relatively easy, there can be challenges in placing plastic spring feet on a metal movable part. The following embodiments can address this issue.

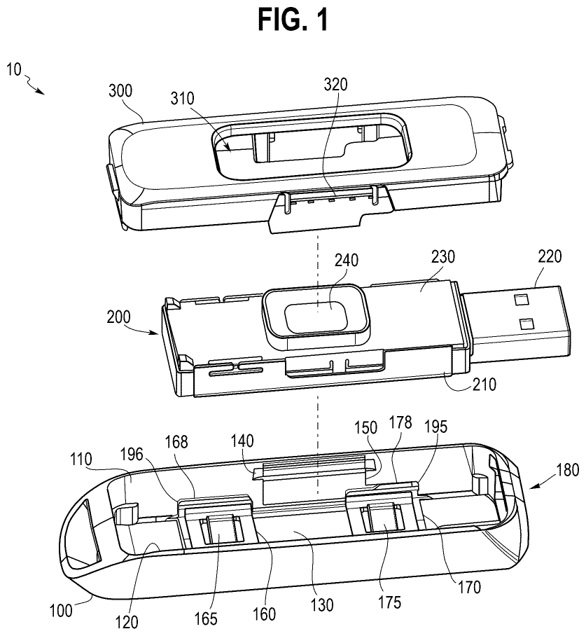

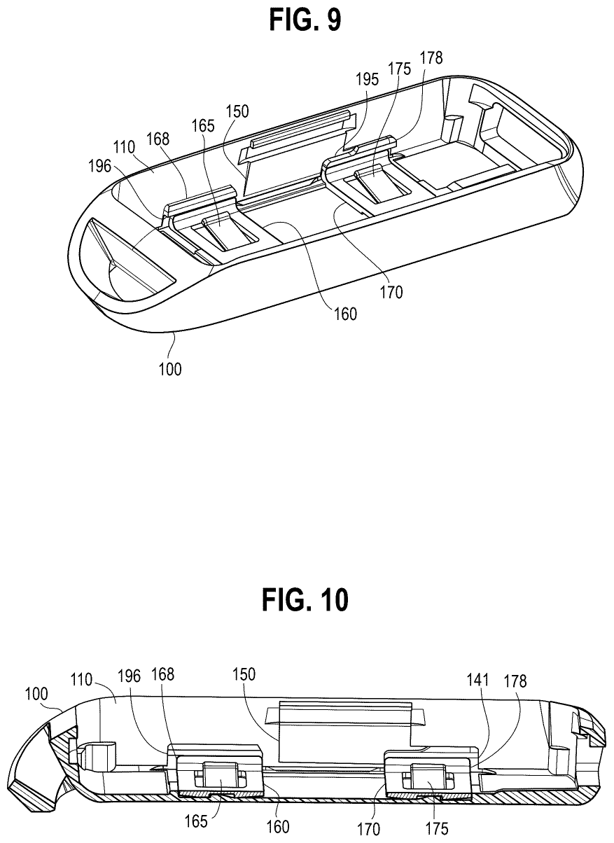

Turning now to the drawings, FIGS. 1-13 are illustrations of a data storage device 10 of an embodiment. In this example, the data storage device 10 takes the form of a Universal Serial Bus (USB) “thumb drive” with a USB Type-A connector. However, it should be understood that different types of connectors and/or different types of data storage devices can be used with these embodiments.

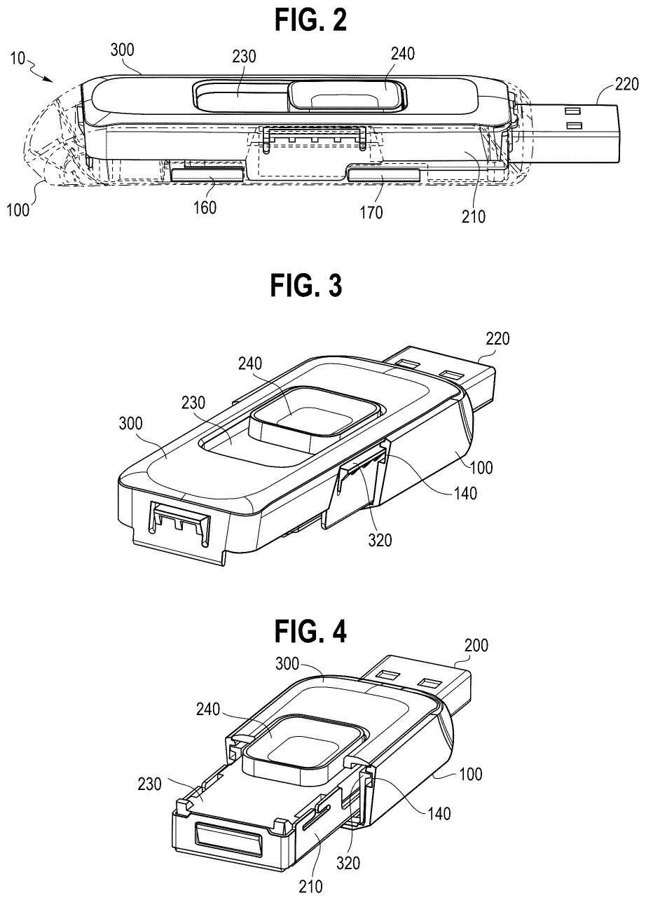

FIG. 1 is an expanded, unassembled view of the data storage device 10, and FIG. 2 is a semi-transparent view of the assembled data storage device 10. As shown in FIG. 1, the data storage device 10 in this example comprises a bottom enclosure 100, a movable connector assembly 200, and a top enclosure 300. The data storage device 10 is assembled by snapping the three components 100, 200, 300 together.

In this example, the bottom enclosure 100 comprises first and second side walls 110, 120 in between a bottom surface 130. The first and second side wall 110, 120 comprises a pair of recesses 140, as well as a gap 150 between first and second pairs of grooves 195, 196 defined in the first and second side walls 110. (The paired portions in the second side wall 200 are not visible in the view shown in FIG. 1._ The recesses 140 are used to receive protruding portions of the top enclosure 300 to secure (snap) those two components togethers. The gaps are used to receive first and second biasing members 160, 170 during the assembly process of the data storage device 10, which will be described in more below. It should be noted that while the example shown in FIG. 1 contains two biasing members 160, 170, in other implementations, more than two biasing members or only a single biasing member can be used. The bottom enclosure 100 also comprises an opening 180 through which a connector 220 of the connector assembly 200 can protrude when the connector 220 is moved from a retracted position (where the connector 220 is inside the bottom enclosure 100) and an extended position (where the connector 220 is exposed outside the bottom enclosure 100). In one embodiment, the bottom enclosure 100 is made of metal (e.g., diecast aluminum).

As mentioned above, the connector assembly 200 has a connector 220 (which is sometimes referred to herein as an electrical connector). In this example, the connector 220 is supported by a bracket 210, which also supports a printed circuit board (PCB) assembly (not shown). In this embodiment, the bracket 210 is metal, which provides better heat dissipation than plastic (in other embodiments, plastic or another material can be used). Distal ends of metal leads are exposed inside the shell of the connector 210, and proximal ends of the metal leads are electrically coupled with the printed circuit board. As used herein, “coupled with” can be mean directly coupled with or indirectly coupled with via one or more components which may or may not be shown or described herein. For example, the proximal ends of the metal leads can be soldered directly or indirectly via wires onto the printed circuit board. The connector 110 is configured to be inserted into a receptable/port in a host, so that the exposed distal ends of the metal leads can physically and electrically mate with corresponding metal leads in the host to provide electrical connectivity. The metal leads can be configured to transmit electrical signals to communicate data and related commands/signals between the data storage device 10 and the host. The metal leads can also be configured to communicate power from the host to the data storage device 10.

The printed circuit board can also be coupled with a memory and a controller. The memory can take any suitable form. For example, the memory can comprise one or more non-volatile memory dies with single-level cells (SLC) or multiple-level cells (MLC) (e.g., dual-level cells, triple-level cells (TLC), quad-level cells (QLC), etc.) and can be fabricated in a two-dimensional or three-dimensional fashion. Any suitable technology, now existing or later developed, can be used. In one example implementation, the memory takes the form of a flash memory in a NAND configuration (NAND memory). However, other forms of memory can be used, such as, but not limited to, resistive random access memory (“ReRAM”), electrically erasable programmable read only memory (“EEPROM”) (flash memory can also be considered a subset of EEPROM), ferroelectric random access memory (“FRAM”), magnetoresistive random access memory (“MRAM”), and other semiconductor elements capable of storing information. Further, in addition to or instead of having non-volatile memory, the data storage device can have volatile memory.

The controller can also take any suitable form. For example, the controller can comprise one or more processors that are, individually or in combination, configured to perform various functions by executing computer-readable program code stored in one or more non-transitory memories inside and/or outside the controller. As another example, the controller can be a pure hardware implementation (e.g., an application specific integrated circuit (ASIC)). In general, the controller can be configured to facilitate data transfer between the memory and a host. The host can take any suitable form, such as, but not limited to, a computing device that can provide commands to read and/or write data (e.g., a computer, a smart phone, a tablet, a set-top box, a game console, a vehicle, etc.) or a peripheral to such a device (e.g., a monitor with a USB port, a hub/docking station, another data storage device, etc.).

Referring back to FIG. 1, the connector assembly 200 also comprises a button assembly 230 that has a button 240 formed thereon. The button 240 can be integrated into the button assembly 230 or can be affixed therein. In this example, the button assembly 230 (here, plastic) snaps onto the bracket 210 (here, metal). To assemble the data storage device 10, the connector assembly 200 would be placed in the bottom enclosure 100, and the top enclosure 300 would snap onto the bottom enclosure 100.

As shown in the semi-transparent view in FIG. 2, the top enclosure 300 has an opening 310 formed therein to receive the button 240 and allow the button 240 to move back and forth to move the connector assembly 200 (and, hence, the connector 220) between the retracted and extended positions (the extended position is shown in FIG. 2). Also, as shown in the cut-away views in FIGS. 3 and 4, when the top enclosure 300 snaps onto the bottom enclosure 100, rails 320 on either side of the top enclosure 300 snap into grooves 140 formed in the bottom enclosure 100. The rails 320 slide along the grooves 140 as the connector assembly 200 moves between the retracted and extended positions.

FIG. 2 also shows the two biasing members 160, 170. As used herein, the term “biasing member” generally refers to a component that has a resilient portion that may be elastically deformed when placed under load (e.g., compression, tension, deflection, torsion, etc.) and that exerts a reactionary force to resist such deformation. In this example, the resilient portions 168, 178 of the biasing members 160, 170 take the form of plastic tabs that are biased upwardly. (The resilient portions 168, 178 are integrated into the biasing members 160, 170 in this example, but they can be separated attached components instead.) These tabs may be sometimes referred to herein as “springs” or “spring feet” even though the tabs are not shaped in a coiled manner like a some springs. It should be noted that a resilient portion can take any other suitable form, including, but not limited to, a spring (e.g., a coiled spring, a leaf spring, a torsion spring, etc.).

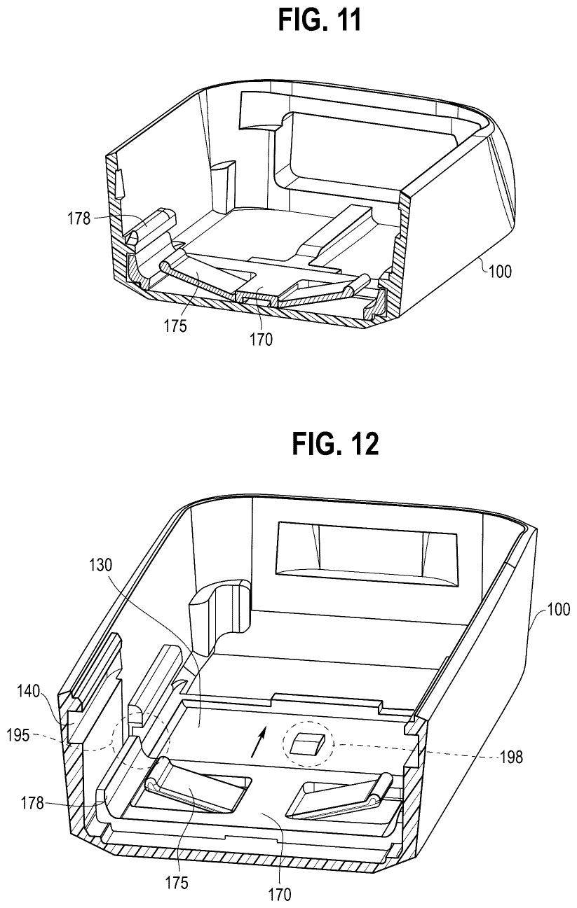

The bottom enclosure 100 is designed to allow assembly of the biasing members 160, 170 onto the bottom enclosure 100. With references to FIGS. 8-12, in this example, the bottom enclosure 100 comprises grooves 195, 196 on either side of a gap 150 in the middle of the two sidewalls 110, 120. Each biasing member 160, 170 would be inserted into the bottom enclosure 100 along the gap 150 and then slid into its respective groove. For example, as shown in FIGS. 11 and 12, after biasing member 170 is placed through the gap 150 onto the bottom surface 130 of the bottom enclosure 100, the biasing member 170 would be slid toward the end of the bottom enclosure 100, such that a mounting portion 178 of the biasing member 170 would engage with the groove 195 in the bottom enclosure 100. “Mounting portion” can refer to both rail members on either side of the biasing member 170-not just the single rail shown in some of the figures. In other embodiments, just one rail or more than two rails are used as the mounting portions. Further, structures other than rails can be used as a mounting portion.

The bottom enclosure 100 can also include a locking mechanism or means for locking the biasing member 170 onto the bottom enclosure 100. In this embodiment, a step 198 snaps into a recess in the bottom side of the biasing member 170 to lock the biasing member 170 after it is slid into place. Other arrangements are possible. For example, one of the biasing member 170 and the bottom enclosure 100 can comprise any suitably-shaped protrusion (not just a step), and the other of the biasing member 170 and the bottom enclosure 100 can comprise a cavity sized to receive the protrusion to lock together the biasing member 170 and the bottom enclosure 100.

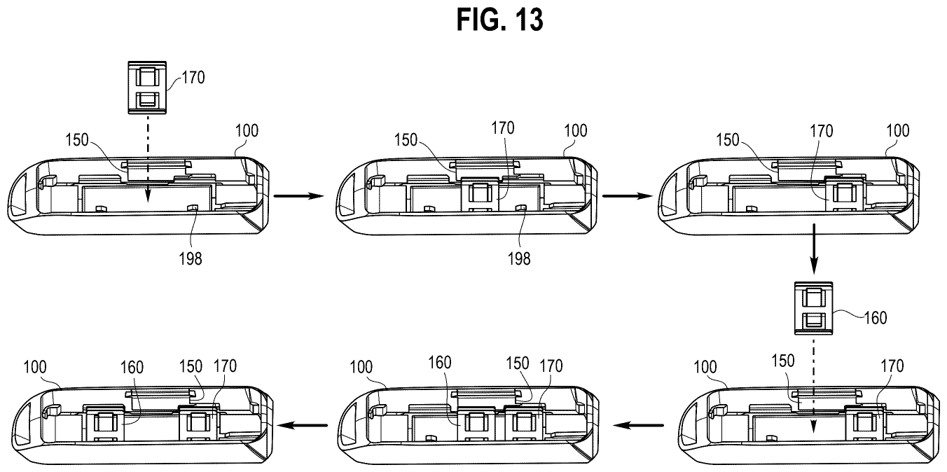

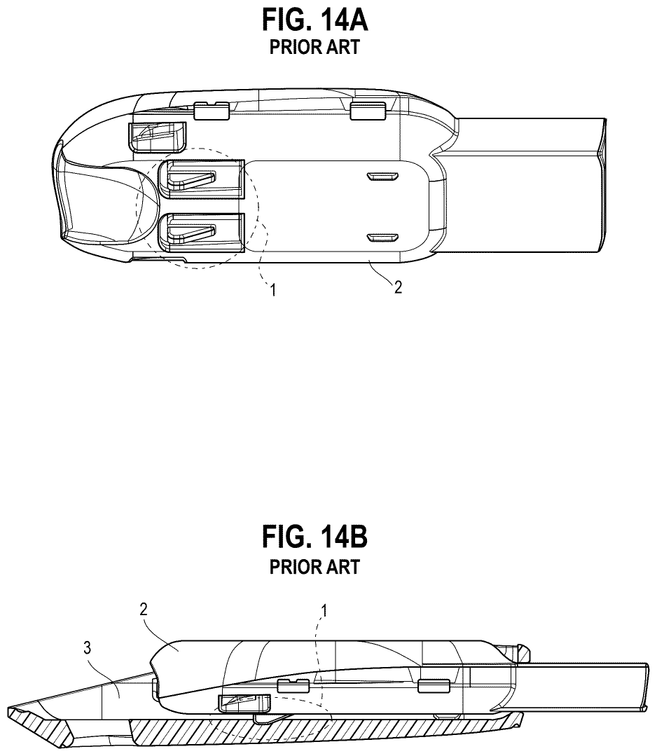

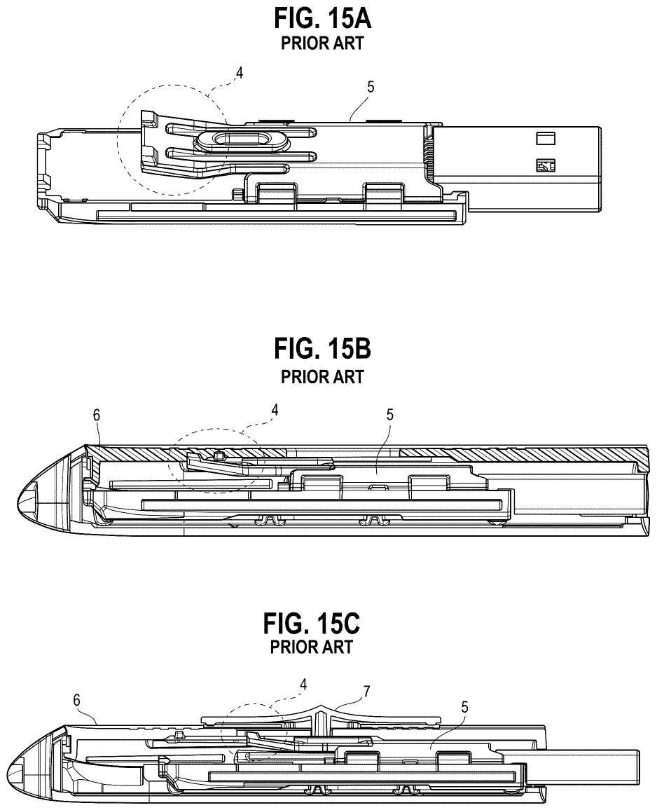

FIG. 13 illustrates the assembly process for this embodiment in a step-by-step manner for each biasing member 160, 170. As shown in this figure, the two biasing members 160, 170 would sequentially (one by one) be aligned with the gap 150 in the bottom enclosure 100, placed through the gap 150 and onto the bottom surface 130 of the bottom enclosure 100, slid right or left, as appropriate, and snapped into place. Once assembled, the movable connector assembly 200 can sit on the biasing members 160, 170 and slide along them, and the biasing members 160, 170 would provide a spring force to the connector assembly 200.

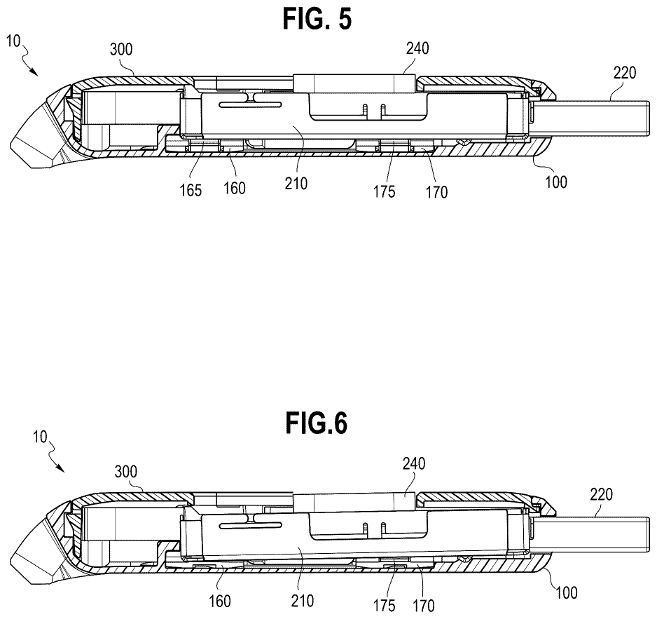

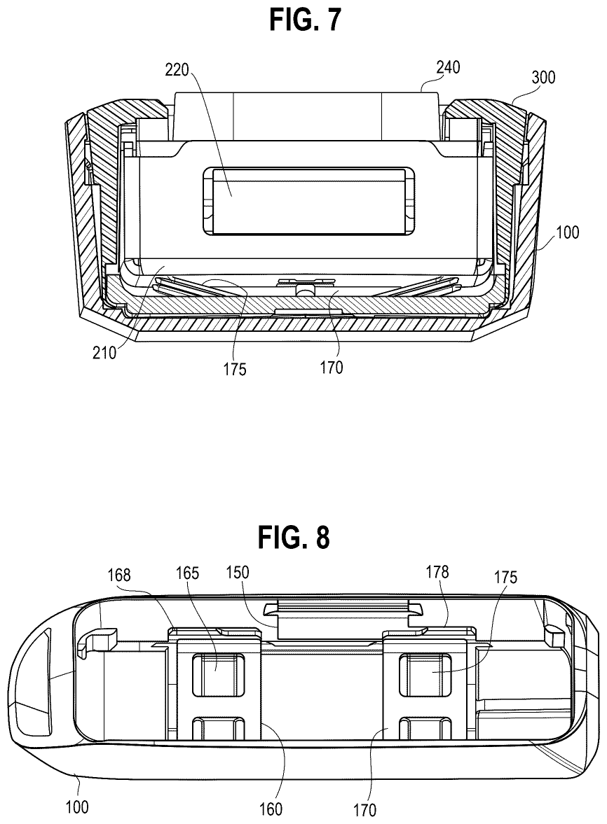

As mentioned above, the biasing members 160, 170 are used to releasably retain lock the connector assembly 200 in place when in the retracted and extended positions. For example, in some embodiments, the bottom surface of the bracket 210 of the connector assembly 200 has recesses that are shaped to receive the resilient portions 168, 178 of one or both the biasing members 160, 170 when the connector assembly 200 is in the retracted and/or extended positions. When the connector assembly 200 is in the retracted and/or extended positions, the resilient portions 168, 178 of the biasing members 160, 170 are in a less deflected or undeflected state, and those portions 168, 178 are received in the recesses in the bottom surface of the bracket 210 of the connector assembly 200. This firmly positions the connector assembly 200 in the bottom enclosure 100 and eliminates back-and-forth shifts of the connector assembly 200 (see FIGS. 2 and 7). FIG. 5 shows the connector assembly 200 positioned in the extended position (a similar situation can occur when the connector assembly 200 is positioned in the retracted position). In the state shown in FIG. 5, the connector assembly 200 sits on the two biasing members 160, 170, which provide slight upward support force, which comes from spring pre-deformation. This support force ensures more reliable locking.

To release the connector assembly 200 from the locked, extended position in FIG. 5, a user would push down the button 240, which would cause the bracket 210 of the connector assembly 200 to push downward (see FIG. 6). In this locking release state when the button 240 is pushed down, the locking is released, and the spring deformation increases, which provides a bigger support force. Here, the left-side biasing member 160 deforms more than the right-side biasing member 170. The user would then slide the button 240 to move the connector assembly 200, thereby retracting the connector 220 inside the data storage device 10. As shown in FIG. 7, when moved between the retracted and extended positions, the flat bottom portion of the bracket 210 of the connector assembly 200 sits on and slides along the top of the biasing members 160, 170. This can provide a smooth feeling for the user as the user slides the button 240.

There are several alternatives that can be used. For example, the connector assembly 200 can have a recess to receive the resilient portion 165, 175 of only one of biasing members 160, 170, instead of having recesses to receive both. In another alternative, the connector assembly 200 does not have recesses for one or both of the resilient portions 165, 175. Instead, the spring forces of the resilient portions 165, 175 are sufficiently strong to retain the connector assembly 200 in place. Further, in any of these configurations, the retaining mechanism can be designed such that the connector assembly 200 is releasably retained in both the retracted and extended positions, in just one of those positions, and/or in another position.

There are several advantages associated with these embodiments. For example, as noted above, it may be preferred to use a metal movable part instead of a plastic movable part, as metal can provide a good heat sink. However, while forming a plastic biasing member (e.g., spring feet) on a plastic movable part is relatively easy, there can be challenges in placing a plastic biasing member on a metal movable part. These embodiments can broaden the types of materials that can be used for the movable connector assembly without being constrained by the design of the biasing member. For example, the bracket of the connector assembly can be made of metal, which can provide improved heat dissipation and improved read/write speeds. Further, using biasing members mounted onto a bottom enclosure of a data storage device can provide even resilient force to the movable connector assembly. These embodiments can also allow for a neat and clean design for the connector assembly.

### CONCLUSION

It is intended that the foregoing detailed description be understood as an illustration of selected forms that the invention can take and not as a definition of the invention. It is only the following claims, including all equivalents, that are intended to define the scope of the claimed invention. Finally, it should be noted that any aspect of any of the embodiments described herein can be used alone or in combination with one another.

What is claimed is:

1. A data storage device comprising:
a bottom enclosure comprising first and second sidewalls, wherein a pair of grooves are formed in the first and second sidewalls;
a biasing member comprising a resilient portion and a mounting portion, wherein the mounting portion is slidably engaged with the pair of grooves; and
a connector assembly comprising a connector, wherein the connector assembly is slidable along the resilient portion of the biasing member between a retracted position in which the connector is positioned inside the bottom enclosure and an extended position in which the connector is positioned outside of bottom enclosure, wherein the resilient portion of the biasing member is configured to releasably retain the connector assembly in place.

2. The data storage device of claim 1, wherein the bottom enclosure is made of metal.

3. The data storage device of claim 1, wherein the biasing member is made of plastic.

4. The data storage device of claim 1, wherein the connector assembly further comprises a metal bracket that carries the connector and a printed circuit board that is electrically coupled with electrical leads inside the connector.

5. The data storage device of claim 1, further comprising:
a second pair of grooves are formed in the first and second sidewalls; and
a second biasing member comprising a second resilient portion and a second mounting portion, wherein the second mounting portion is slidably engaged with the second pair of grooves;
wherein a gap exists between both pairs of grooves, the gap sized to receive the first and second biasing members.

6. The data storage device of claim 1, wherein:
the connector assembly further comprises a button; and
the data storage device further comprises a top enclosure having an opening formed therein sized to receive the button.

7. The data storage device of claim 1, wherein one of the biasing member and the bottom enclosure comprises a protrusion, and the other of the biasing member and the bottom enclosure comprises a cavity sized to receive the protrusion to lock together the biasing member and the bottom enclosure.

8. A data storage device comprising:
a top enclosure;
a bottom enclosure comprising first and second sidewalls, wherein first and second pairs of grooves are formed in the first and second sidewalls;
a first biasing member comprising a first resilient portion and a first mounting portion, wherein the first mounting portion is slidably engaged with the first pair of grooves;
a second biasing member comprising a second resilient portion and a second mounting portion, wherein the second mounting portion is slidably engaged with the second pair of grooves; and
a connector assembly positioned between the top and bottom enclosures, the connector assembly comprising a connector, wherein the connector assembly is slidable along the first and second resilient portions of the first and second biasing member between a retracted position in which the connector is positioned inside the bottom enclosure and an extended position in which the connector is positioned outside of bottom enclosure.

9. The data storage device of claim 8, wherein the bottom enclosure is made of metal.

10. The data storage device of claim 8, wherein the first and second biasing members are made of plastic.

11. The data storage device of claim 8, wherein the connector assembly further comprises a metal bracket that carries the connector and a printed circuit board that is electrically coupled with leads inside the connector.

12. The data storage device of claim 8, further comprising means for locking the first and second biasing members onto the bottom enclosure.

13. The data storage device of claim 8, wherein the connector assembly further comprises a button, and wherein the top enclosure comprises an opening sized to receive the button.

14. A data storage device assembled by a process comprising:
providing a bottom enclosure comprising first and second sidewalls, wherein first and second pairs of grooves are formed in the first and second sidewalls and a gap exists between the first and second pairs of grooves;
placing a first biasing member through the gap, the first biasing member comprising a first resilient portion and a first mounting portion;
sliding the first mounting portion of the first biasing member through the first pair of grooves;
placing a second biasing member through the gap, the second biasing member comprising a second resilient portion and a second mounting portion; and
sliding the second mounting portion of the second biasing member through the second pair of grooves.

15. The data storage device of claim 14, wherein the first and second mounting portions of the first and second biasing members are slid through the first and second pairs of grooves, respectively, until the first and second biasing members engage with respective first and second locking mechanisms in the bottom enclosure.

16. The data storage device of claim 14 wherein the bottom enclosure is made of metal.

17. The data storage device of claim 14, wherein the first and second biasing members are made of plastic.

18. The data storage device of claim 14, wherein the process further comprises:
placing a connector assembly on top of the first and second resilient portions of the first and second biasing members.

19. The data storage device of claim 18, wherein the connector assembly comprises a metal bracket that contacts the first and second resilient portions of the first and second biasing members.

20. The data storage device of claim 14, wherein the process further comprises:
snapping a top enclosure onto the bottom enclosure.
